(19) United States
(12) Patent Application Publication
(10) Pub. No.: US 2015/0211434 A1
(43) Pub. Date: Jul. 30, 2015

(54) PROCESS AND SYSTEM FOR REDUCING THE AMOUNT OF FUEL IN VEHICLES EQUIPPED WITH FUEL INJECTORS AND THAT CAN BE SUPPLIED WITH MORE THAN ONE FUEL

(71) Applicant: A.E.B. S.P.A., CAVRIAGO (REGGIO EMILIA) (IT)

(72) Inventors: Stefano Campani, Cervarezza Terme (IT); Maicol Tondelli, Bagnolo In Piano (IT)

(21) Appl. No.: 14/420,250

(22) PCT Filed: Jul. 29, 2013
(86) PCT No.: PCT/IB2013/056224

§ 371 Date: Feb. 6, 2015

(30) Foreign Application Priority Data
Aug. 10, 2012 (IT) PR2012A000054

(51) Int. Cl. F02D 41/40; F02D 41/14; F02D 41/00

(52) U.S. Cl. CPC F02D 41/403; F02D 41/0025; F02D 41/14

(57) ABSTRACT

Process for reducing the amount of fuel in vehicles equipped with fuel injectors and that can be supplied with more than one fuel, comprising a piloting step of one or more injectors (3) with a real pressure pr, through a control unit (1) and a high pressure pump (2), wherein the control unit (1) receives an incoming feedback pressure signal Pf from a pressure sensor (4), and characterised in that an emulation step of the pressure sensor (4) is envisaged consisting of altering the transfer function of a feedback loop on which the pressure sensor (4) is located according to the law: Pf=pr·k(pv), where pv are typical engine control parameters and k(pv) is a function of it, with k(pv)>1, i.e. Pf≧pr> and pr=pt/k(pv) i.e. pr≦pt in which pt is the target pressure of said control unit (1).

### TECHNICAL FIELD

The present invention relates to a process and system for reducing the amount of fuel in vehicles equipped with fuel injectors and that can be supplied with more than one fuel. The current invention is intended to be inserted within the field of strategies for reducing the amount of fuel used by vehicles, in particular cars, in order to be replaced by an alternative fuel.

### BACKGROUND ART

The principle on which the operation of alternative fuel cars is based is that of replacing the original petrol or diesel supply with alternative less-polluting fuels, while maintaining the same carburation as far as possible and ensuring that the electronics of the vehicle are not affected by this replacement. This principle obviously needs the implementation of a strategy that allows the injection of the original fuel to be reduced as much as possible and at the same time the checks performed by the car's ECU (Electronic Central Unit) to be sidestepped which would otherwise signal a malfunction. The current strategies of reducing the amount of fuel injected into the combustion chamber envisage “cutting” and consequently “emulating” the injectors of the original fuel: the injectors of the original system are inhibited by interrupting the electric connection that allows the original control unit to open and close such actuators, and at the same time the load emulation strategies are implemented so as to ensure that the control unit cannot diagnose an injector piloting failure.

However, this solution implies considerable implemental complications. In fact, the strategy of cutting and emulating the original injectors envisages intervening in the piloting sector of the car's injectors and actually “cutting” the electrical continuity between the ECU and the injectors at the time of injection, so that the opening and closing controls do not produce any effects and hence the injector remains closed. Obviously the vehicle's ECU actuates control strategies that envisage the assessment of feedback from the injector to testify its effective opening. This feedback is usually represented by the current crossing the injector coil which is excited at the time of opening in order to activate the shutter which consequently allows the passage of fuel and the reading of the voltages to the injector heads under particular conditions.

FIG. 1 shows an acquisition of a general waveform of the injector piloting current.

The ECU performs the checks on the current levels in order to establish whether the opening took place correctly. Most of the time for example it checks that the maximum current peak is reached within a certain amount of time, or that the current levels during some of the piloting stages are within pre-set limits.

Through the “cutting” strategy of the injector the coil is obviously not excited and consequently the feedback does not reach the ECU which in this situation will recognise a malfunction and hence implement a diagnostic strategy.

Therefore it is necessary to emulate the behaviour of the injector in order to provide this feedback, simulating the trend of the current that would cross the injector coil.

This simulation is obtained through a hardware layer assembled on the alternative fuel supply control system, which reproduces a similar current to that which would be produced in the injector coil and which will be read as feedback from the vehicle's ECU. The hardware emulation layer usually comprises passive elements (for example resistances) that are connected to the battery voltage when it is time to emulate and then crossed by a current that will actually simulate that of the injectors.

The main drawbacks in the implementation of the cutting and emulation strategy are connected with the generation of the emulation current, which in order to simulate the trend of the injector piloting currents must reach levels of a few Amps and in more recent systems must be able to reach a peak level of over 10 A.

In fact, in modern injectors in order to obtain very high opening speeds, rather high peak currents are used.

The difficulties faced in the implementation of the layer for emulating such high currents are connected with dimensions and temperature. In fact, the circuit elements that comprise the emulation layer must be remarkably large in order to be able to handle the energy produced by the high current, which naturally goes against the need to reduce the size on the electronic boards. Furthermore, the energy is dissipated by the passive elements in the form of heat, causing very high heating of the electronic board which is difficult to handle.

It is therefore difficult to emulate the high levels of current in the injectors of the latest generation of cars, with direct injection or common rail diesel in which the maximum peak reached by the current piloting the injector reaches very high levels (10-20 Amps), which are difficult to reproduce with the method just described.

To overcome this impossibility it is sometimes necessary to let the injector open normally by starting the cutting and emulation strategy only once the current has reached a certain value which, added to that which can be generated through the emulation circuit, causes the current peak expected by the original control unit. Doing so lets a significant fraction of the original fuel pass through, whose quantity increases the more difficult it is to emulate the behaviour of the injector.

By applying the injector cutting strategy, another problem arises. The fact that the injectors are not left open, or that a small amount of fuel is let through, makes the pressures of the supply rails increase substantially, often reaching levels close to the vehicle's maximum limit. This happens because the high pressure pumps normally continue to introduce fuel into the injection rail without there being an outlet (opening of the injectors) as normally happens.

Hence the problem also arises that the mechanical components of the injection system are put under great strain during operation with alternative fuel, with the risk of premature breaking.

Another solution, described in WO2009/133399, envisages the reduction of the pressure by the auxiliary control unit (the gas one), which acts directly on the pump.

Document WO2010/103288, on the other hand, envisages bringing the control unit to a higher pressure level so that the control unit lowers the piloting pressure of the injectors. The main drawback of this solution resides in the fact that the resulting incoming pressure to the control unit is not connected to the actions that the control unit undertakes on the pump, therefore lowering the real pressure of the fuel often causes the system's diagnostic strategies to intervene.

### DISCLOSURE OF THE INVENTION

The object of the present invention is to provide an alternative or complementary strategy to that mentioned above, which is less complex to implement and reduces the contraindications to a minimum.

A further object is to make a simple and reliable process available in order to reduce the original fuel by replacing it with an alternative fuel.

Said objects are fully reached by the process and the system referred to by the present invention which are characterised by the contents of the claims below and in particular by the fact that they envisage the insertion of an emulator device of a pressure sensor within a feedback loop through which the supply pressure of the fuel to the injectors is defined.

### BRIEF DESCRIPTION OF DRAWINGS

This and other features are better highlighted by the following description of a preferred embodiment, illustrated by way of non-limiting example in the attached figures, wherein:

FIG. 1 shows a general waveform of the injector piloting current;

FIG. 2 illustrates a feedback pattern according to the known art;

FIG. 3 illustrates a feedback pattern according to the present invention.

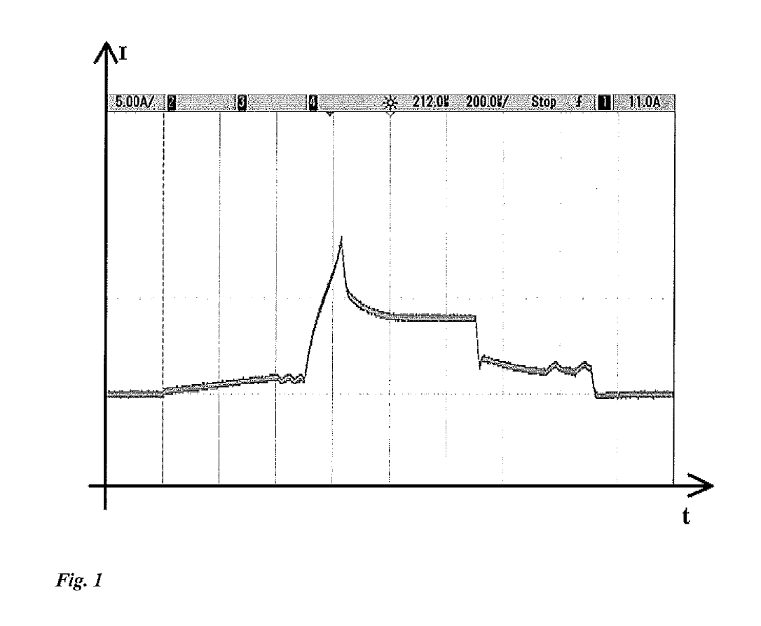

### DETAILED DESCRIPTION OF PREFERRED EMBODIMENTS OF THE INVENTION

With reference to the figures, the number 1 indicates an ECU or control unit of the vehicle, which pilots a high pressure pump 2 and an injector 3 to supply the engine with the necessary amount of fuel under the various engine conditions.

On the feedback loop a pressure sensor 4 is envisaged.

If we define

pₜ=target pressure of the ECU

p_{f}=feedback pressure

pᵣ=real injector supply pressure

then (according to the known art) pᵣ=pₜ and p_{f}=pᵣ

The present invention seeks to offer a solution to the drawbacks of the known art implicit in the injector cutting and injectors emulation strategy, which enables the drawbacks of the known art to be overcome, maintaining as a final objective that of limiting as far as possible the contribution of original fuel that supplies the car's engine.

With the same section of the injector nozzle the amount of fuel injected depends on the opening time of the injector and the pressure level of the latter; as a first approximation the relationship is linear with the time and follows a square root pattern with the pressure of the fuel.

Originally the present invention envisages ensuring that such pressure is much lower than the pressure it would be at under normal conditions, so as to substantially reduce the injection of fuel and the stress on the mechanics of the high pressure system. Therefore, innovative action is taken on the supply pressure of the fuel to the injectors, rather than inhibiting the injectors (more complex).

The amount of fuel that reaches the engine can be regulated both by acting on the pressure and on the injection time. One of the objects of the present invention is that of lowering the real pressure pᵣ in order to have less fuel injected in the same amount of injection time. This happens by interposing an emulating device 5 between the pressure sensor 4 and the control unit 1 which falsifies/modifies the information on pressure sent by the sensor to the control unit.

It is not normally possible to completely eliminate the supply of fuel since pᵣ≠0, but for mixed-fuel vehicles this is positive since the presence of diesel (original fuel) along with the gas (alternative fuel) facilitates the ignition of the gas and at the same time prevents any possible obstruction of the holes present on the injector nozzles.

In more modern petrol engines (particularly in direct injection systems) and in diesel engines the injection of fuel takes place directly in the combustion chamber and the injectors have an increasingly smaller nozzle, therefore the pressure plays an increasingly important role in determining the amount of fuel injected. In order to provide an idea of the pressure levels involved in the different systems it is sufficient to say that the pressure levels of a direct injection petrol engine work at pressures of 30-50 bar up to 120-180 bar, whereas for common rail diesel engines they range from a minimum of 200-300 bar to a maximum of 1500 bar.

As a first approximation the amount of fuel injected is therefore proportional to the square root of the pressure level of the fuel. If it is possible to ensure that the real pressure becomes a fraction of the pressure that would be found under standard conditions, the amount of original fuel injected can be substantially reduced.

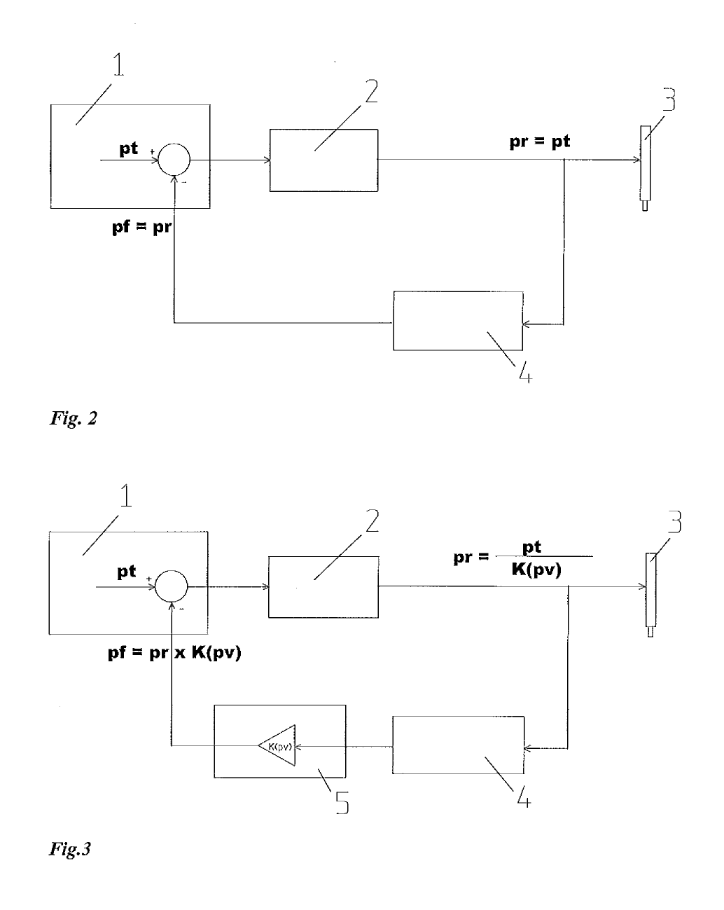

The high pressure of the fuel is reached due to the use of mechanical or electronic pumps that are controlled by the original electronic control unit of the vehicle through a negative feedback loop with a pressure sensor on the supply rail in order to maintain the desired target pressure for injection in a particular engine point. Therefore to maintain the desired pressure the ECU pilots the pump based on the pressure feedback from the pressure sensor which usually has a linear response characteristic, providing a proportional voltage to the pressure level measured. FIG. 2 shows the conceptual block diagram of the feedback system just described, which is part of the known art.

The innovative idea is to modify the transfer function of the pressure sensor 4 that provides the system feedback by emulating its behaviour so that it reports altered information to the ECU on the real pressure level at the pump outlet, making the real pressure of the fuel lower; in particular, through an emulator (illustrated in FIG. 3) the ECU receives information of greater or equal pressure to the effective level so that it tends to lower the piloting of the pump and consequently the real pressure of the fuel.

Therefore p_{f}=pᵣ·k(pv) (with k(pv)≧1, where pv (vehicle parameters) indicates a set of one or more typical engine control variables), i.e. p_{f}pᵣ and pᵣ=pₜ/k(pv) i.e. pᵣ≦pₜ.

The function k(pv) in the simplified version may simply be a higher number than one regardless of the engine conditions (in that case the implementation is very simple, but optimised results are not obtained) or it may be a function that takes into consideration one or more descriptive variables of the engine point so as to optimise the pressure cut in the various engine points (descriptive conditions of the engine operation). The function K(pv) can also take into consideration the log of the descriptive variables of the engine point in order to obtain better optimisation of the transitory conditions (in that case the function can be indicated as K(pv,t) so as to highlight this further dependence of the time variable t).

These clarifications are just some of the possible implementation examples of the transfer function of the emulation block to be inserted in the pressure feedback loop.

The typical engine control parameters pv may be for example:
Manifold absolute pressure (MAP)
Mass airflow (MAF)
Engine revolutions (rpm)
Throttle position (TP)
Original fuel injection times
Calculated engine load value
Air fuel ratio (AFR).

Clearly these parameters are indicated by way of non-limiting example.

The function k(pv) normally has a higher value than one.

However, the case of equal to one has also been considered for some engine points, particularly for example at the minimum number of revolutions, a condition in which it is best to be able to envisage operation without altering the pressure.

However, the operation never takes on a value of less than one since this would cause the opposite effect to the objective of the present invention, i.e. an increase in the real injection pressure value.

The ECU of the original system performs diagnostic checks on the information received from the pressure sensor 4 and on the piloting of the pump 2. It is not possible, for example, to make the control unit read a very high fixed pressure so that it reduces the real pressure of the fuel, otherwise the diagnostic strategies would immediately identify a failure in the system, since the ECU tries to vary the piloting of the pump but does not see any effects on the pressure of the system. There must always be a correlation between the behaviour of the pressure read by the sensor 4 and the piloting of the pump 2 actuated by the control unit 1. If it were attempted to emulate the pressure signal read by the original ECU with a fixed value, or with “open loop” calculated pressure values, it would be difficult to be able to reduce the real pressure of the fuel without a malfunction diagnosis being signalled.

The pressure signal read as feedback from the original ECU must always be correlated to the actions that it performs on the high pressure pump. The present invention proposes an emulation method through intervening on the feedback transfer function which always guarantees that this correlation exists.

The principle expressed in the present invention, as illustrated in FIG. 3, is applied through the innovative insertion of a functional block (the emulator device 5) in the feedback loop, which alters the response characteristic of the sensor, increasing the pressure read by the sensor. In this way the feedback loop is stabilised at a lower injector supply real pressure than the target set by the original control unit, but the correlation between the piloting of the pump and the response of the system remains valid, preventing the generation of diagnostic errors.

By making sure that the ECU is sent pressure information that is greater than or equal to the effective pressure level, the feedback loop tends to make the pressure generated by the pump lower, by stabilising at a value that will be a fraction of the target one required by the ECU.

If for example the feedback pressure value read is doubled by altering the voltage of the sensor appropriately, the feedback loop stabilises so that the real output pressure is half the value required by the ECU.

The strategy described above is implemented through the emulator 5, which comprises a very simple hardware layer (since it must only generate an electric signal, therefore without the need to pilot high currents) provided on the alternative supply system control unit, located after the pressure sensor in series at the section comprised between the latter and the ECU (actually interrupting its direct connection), in order to allow the controlled amplification of the feedback signal by bringing it to a value for which the effective pressure is lowered to the desired level in order to reduce the consumption of the original fuel.

The emulator 5 then, through a software logic, enables the size of the parametric emulation to be maintained, in order to be able to vary it for example according to the different engine conditions or optimise it based on the functional requirements of different vehicles. At low speeds, for example, there is not the same emulation margin as at high speeds, since when the engine load is low, the pressure generated by the pumps is usually very low and in that case the injection of fuel is quite contained since the engine does not require the production of high power levels.

However, when the engine load is high, the pumps usually work on almost full load generating high pressures and under these conditions it is possible to actuate substantial emulations, hence maintaining a much lower pressure than that which would be found under normal conditions. In this way it is fairly easy to intervene on the injection of fuel hence substantially reducing the injection in the high consumption phases.

The present innovative solution for reducing the amount of original fuel injected into the engine has remarkable advantages with respect to the cutting and emulation of the injector of the known prior art, since in the present case the trend of a low power signal is emulated, whereas in the known art the only option was to reproduce the trend of a high current.

The process and system presented herein enable the correlation between the feedback pressure signal read by the control unit and the piloting of the actuators that generate the pressure (diesel pump, discharge valve, etc.) to be maintained, simply by virtually modifying the feedback loop transfer function, hence avoiding diagnostic problems or the intervention of recovery strategies by the original diesel control unit.

A further advantage is given by the fact that a reduction of the working pressure of the components on the injection rail can be arranged, unlike what happens by disengaging the injectors. This means that no problems arise due to premature breaking or excessive stress on the mechanical components on the injection system.

Also from a cabling point of view it is much simpler to install a pressure emulation system than an injector emulation system, since in the former case only one wire needs to be interrupted (the sensor wire) and only one signal needs to be regenerated, whereas in the latter case it is necessary to interrupt as many wires as the number of injectors on the car (typically 4, 6 or 8) and recreate the behaviour of all these power actuators. In certain cases to simulate the behaviour of the injectors it is even necessary to intervene on the injector positive cable and the negative one, hence doubling the number of cables to be interrupted and power signals to be regenerated.

According to a non-illustrated embodiment, the two principles (pressure emulation and injector inhibition/choking) are not mutually exclusive, but the strengths of both can be used in combination in order to completely optimise the conversion system of alternative fuel cars:

complete interruption/choking of the original fuel flow by cutting the injectors for the whole injection time or part of it and at the same time maintaining low pressure levels for the original fuel, in order to reduce the pressure of the original fuel.

By cutting/choking the original fuel very high pressures would be generated, much higher than the normal operating conditions since with the cutting technique of the original injector the opening of the latter is totally/partially inhibited hence preventing the system that generates the high pressure from having an outlet for the original fuel; this can lead to diagnostics or malfunctioning by the ECU.

Preferably the pressures should be kept at fairly contained levels, for example less than two thirds of the maximum working pressure of the vehicle. In order to have an idea of the level for example in a direct injection vehicle the maximum working pressures are in the region of 100-150 bar, therefore the pressures should be kept below 60-100 bar. In a diesel vehicle the maximum working pressures are in the region of 1000-1500 bar therefore, they should be kept below 600-1000 bar. Clearly the use of both techniques allows optimal results to be obtained, although it causes a complication on the conversion system.

The pressure emulation system is also very well suited to conversions of mixed fuel diesel engines (diesel-methane or diesel-LPG) since in this case the spark plugs are not present for igniting the fuel. So as not to have to modify the engines by adding the spark plugs and perhaps changing the compression ratio (a very expensive modification) self-ignition often tends to be used in order to compress the diesel in order to have combustion of the alternative fuel too, which would otherwise not be burnt due to compression; for this purpose it is therefore essential to let a certain amount of diesel through in order to ignite the alternative fuel.

Also in direct injection petrol systems, the fact that a bit of petrol is let through by the injectors can have a beneficial effect on the injectors themselves. In fact, being positioned directly in the combustion chamber they are subjected to any residual soot deposited on the nozzle. Never being cleaned by petrol passing through it sometimes gets completely obstructed preventing the correct operation of the injector when the car is operating with the original fuel. In addition to this, the petrol passing into the injectors also has a cooling function thereof since, being located directly in the combustion chamber, they are exposed to very high temperatures; no petrol passing through to cool them down could, over time, cause functional problems for the injector.

Some models of injector suffer from such problems, therefore it is best to guarantee a minimum amount of fuel passing through, whereas others have fewer dirt deposit or excessive temperature problems.

1. Process for reducing the amount of fuel in vehicles equipped with fuel injectors and that can be supplied with more than one fuel, comprising a piloting step of one or more injectors (3) with a real pressure pᵣ≠0, through a control unit (1) and a high pressure pump (2), in which said control unit (1) receives an incoming feedback pressure signal p_{f} from a pressure sensor (4),
characterised in that it comprises an emulation step of the pressure sensor (4) consisting of altering the transfer function of a feedback loop on which said pressure sensor (4) is located according to the law:
p_{f}pᵣ·k(pv) where pv indicates one or more typical engine control parameters and k(pv) is a function that depends on one or more of said typical parameters, with k(pv)≧1), that is, p_{f}≧pᵣ and pᵣ=pₜ/k(pv) that is, pᵣ≦pₜ in which pₜ is the target pressure of said control unit (1), due to the effect of such an alteration of the transfer function, the feedback pressure signal p_{f} always being correlated to the actions that the control unit (1) performs on said high pressure pump (2).

2. Process according to claim 1, in which k(pv)>1.

3. Process according to claim 1, in which the function k(pv) is a function of one or more typical engine control status parameters chosen from:
Manifold absolute pressure (MAP),
Mass airflow (MAF)
Engine revolutions (rpm)
Throttle position (TP)
Original fuel injection times
Calculated engine load value
Air fuel ratio (AFR).

4. Process according to claim 1 which the function k(pv) is also a function of the parameter log, therefore expressible as k(pv, t) where t is the time.

5. Process according to claim 1, in which there is a complete interruption or choking of the original fuel flow due to the cutting of the injectors, during all the injection time or part of it, and simultaneous maintaining of low pressures for the original fuel, lower than two thirds of the maximum working pressure.

6. System for reducing the amount of fuel in vehicles equipped with fuel injectors and that can be supplied with more than one fuel, in which the vehicle comprises a control unit (1) which pilots a high pressure pump (2) and one or more injectors (3) to supply the engine with the necessary amount of fuel in the various engine conditions so as to generate a real pressure pᵣ≠0, through a high pressure pump (2), in which the control unit (1) receives an incoming feedback pressure signal p_{f} from a pressure sensor (4),
characterised in that it comprises an emulation device (5) inserted in a feedback loop on which said pressure sensor (4) is located and downstream of the latter, said emulation device (5) altering the transfer function of the feedback loop according to the law:
p_{f}=pᵣ·k(pv), where pv indicates a set of one or more typical engine control parameters and k(pv) is a function that depends on one or more of said typical parameters, with k(pv)≧1, that is p_{f}≧pᵣ, and pᵣ=pₜ/k(pv) that is pᵣ≦pₜ in which pₜ is the target pressure of said control unit (1), due to the effect of such an alteration on the transfer function the feedback pressure signal p_{f} always being correlated to the actions that the control unit (1) performs on said high pressure pump (2).
